(19) United States
(12) Patent Application Publication
(10) Pub. No.: US 2009/0151264 A1
(43) Pub. Date: Jun. 18, 2009

(54) Safety door assembly and method for child door safety

(75) Inventor: Clifton N. Boens, Chicago, IL (US)

Correspondence Address: J.T. HOLLIN, ATTORNEY AT LAW, PC, 110 HABERSHAM DRIVE, SUITE 144, FAYETTEVILLE, GA, 30214, US

(73) Assignee: Safety Door International, LLC, Fayetteville, GA (US)

(21) Appl. No.: 12/316,631

(22) Filed: Dec. 15, 2008

Related U.S. Application Data
(60) Provisional application No. 61/008,027, filed on Dec. 18, 2007.

(51) Int. Cl. E06B 3/34; E06B 1/52; E06B 3/30

(52) U.S. Cl. 49/383; 52/204.1; 49/506

(57) ABSTRACT

This inventive concept discloses a door assembly comprising a custom-built doorframe housing a main door, which main door rotates within the doorframe by a major pivotal means. A spring-loaded leaf door is attached, by a minor pivotal means, within a cutout excised from the leading edge of the main door. As the main door rotates about its pivotal axis, the door is restrained from closing with full force upon human fingers or any other object that may be proximate the door jamb, or inner doorframe area.

The pivoting, or trailing, edge of the main door is abutted against elastomeric material affixed to the inner rear surface of the doorframe, thereby serving to prevent the insertion of fingers into what otherwise would be a hazardous gap. The optimal embodiment of this inventive concept features a doorframe having upper and lower ball bearing assemblies for containment and stable support of the main door pivotal means.

### CROSS-REFERENCES TO RELATED APPLICATIONS

U.S. Patent Documents

| | | |
|---|---|---|
| 2,184,259 | Dec. 19, 1939 | Seaman |
| 3,086,383 | Apr. 23, 1963 | Scott |
| 3,141,204 | Jul. 21, 1964 | Wheeler |
| 3,827,183 | Aug. 6, 1974 | Zimmerman, et al. |
| 3,934,371 | Jan. 27, 1976 | Ulatowski, et al. |
| 4,261,140 | Apr. 14, 1981 | McLean |
| 4,290,233 | Sep. 22, 1981 | Hubbard |
| 4,999,949 | Mar. 19, 1991 | Granlund |
| 5,076,017 | Dec. 31, 1991 | Jacobs |
| 5,092,077 | Mar. 3, 1992 | Teinturier-Milgram |
| 5,765,311 | Jun. 16, 1998 | Kapler |
| 6,141,909 | Nov. 17, 2000 | Hanson |
| 6,311,432 | Nov. 6, 2001 | Watson |
| 6,185,871 | Feb. 13, 2001 | Wang |
| 6,434,888 | Aug. 20, 2002 | Shaw, et al. |
| 6,832,450 | Dec. 21, 2004 | Shaharbani |
| 7,047,694 | May 23, 2006 | Salzman |
| 7,234,202 | Jun. 26, 2007 | Li |
| 7,293,328 | Nov. 13, 2007 | Endres |

U.S. Patent Application Publications

| | | |
|---|---|---|
| 2002/0046501 | Apr. 25, 2002 | Webb |
| 2002/0157319 | Oct. 31, 2002 | Haq |
| 2005/0108946 | May 26, 2005 | Shaharbani |
| 2005/0183342 | Aug. 25, 2005 | Holden |

Foreign Patent Documents

| | | |
|---|---|---|
| WO 03/093622 | Nov. 13, 2003 (pub date) | Garvey |
| JP 10072972 | Mar. 17, 1998 (pub date) | Kogyo |

### OTHER REFERENCES

Pediatrics, Vol. 27, No. 5, May, 1961, pg 842
www.fingershield.co.uk
The Martin Finger Shield™ Garage Door System
www.fingerkeeper.co.uk

### PRIORITY CLAIM

This application claims the benefit of provisional patent application No. 61/008,027, filed on Dec. 18, 2007.

### STATEMENT REGARDING FEDERALLY SPONSORED RESEARCH OR DEVELOPMENT

Not applicable.

### NAMES OF THE PARTIES TO A JOINT RESEARCH AGREEMENT

There is no joint research agreement in conjunction with this invention.

### REFERENCE TO A “SEQUENCE LISTING,” A TABLE, OR A COMPUTER PROGRAM LISTING APPENDIX

Not applicable.

### BACKGROUND OF THE INVENTION

(1) Field of the Invention

This inventive concept is directed toward enhancing safety in residences and commercial establishments where the possibility of injury exists due to fingers of children or adults being caught in door closings. Each year approximately 30,000 people, both children and adults are rushed to hospital emergency rooms in the United States because they have accidentally crushed or amputated a finger. The two most common causative factors in severe finger injuries are (1) the use of power tools and (2) closing of doors. According to the National Center for Injury Prevention and Control (NCIPC) in Atlanta, Ga., children aged 4 and younger and men aged 55 and older are the two age groups found to be most at risk for these type injuries. It is estimated that over 1500 door-caused finger injuries are so severe that the injured person requires reconstructive surgery. Fifty-five percent of these accidents occur at home. Car doors and garage doors are also included in these statistics, along with finger injuries caused by revolving doors.

There have been several types of finger guards or door guards marketed, the most common being some type of flexible blocking device attached to the vertical edge of the latching side of a door to prevent it from closing fully. Other devices include concepts such as “gate for doors,” which is an actual gate used in doorways, hallways, and at the top of stairs in order to prevent toddlers from going past a certain point or playfully opening or closing a co-located door. Practically all of these inventions are designed and marketed for the protection of children, but not specifically for adults, who are taller and heavier.

Door guards, which are also known as hinge guards, anti-finger trapping devices, and/or finger guards, protect fingers in door hinges. A closing door can exert up to 40 tons per square inch of pressure between the hinges. Door guards normally cover the gap which exposes the hinges as a door is opened. The most common form of door guard is a length of rubber or other resilient material that attaches either to the trailing edge of a door, or to both the door and the frame, and is flexible enough to cover the hinged gap should the door be fully opened.

(2) Description of the Related Art

The prior art contains a number of door guards and protective devices, either for the hinged trailing edge or the latching, (leading) edge of a door. One notable example is in U.S. Pat. No. 2,184,259, where disclosures similar to embodiments of this invention are made. In particular, there is disclosed the design of a concave frame shape to accommodate the convex end of a door which pivots about a vertical axis defined by upper and lower pins. However, no claims to the safety features of this invention were made.

U.S. Pat. No. 3,141,204 has a uniquely designed door jamb in which the side frame member has transversely movable or flexible pressure plates which will yield in the event an object such as a finger is caught between the edge of a closing door and the side frame.

Several devices are designed to provide a protective shield or covering over the gap in the area of the door hinges when a door is opened. For example, U.S. Pat. No. 4,261,140 features a flexible, retractable shield overlying the front, or outward gap of the hinged area, and a flexible shield overlying the rear or inward gap at the door. This invention also features a door stop device mounted to the front surface of the door which, as the door is moved toward closed, said device is activated to drop into position and block the door from closing, thereby providing protection against injury which might occur between the leading edge of the door and the jamb.

U.S. Pat. No. 4,290,233 features a “detachable finger protector for continuously closing the gap formed between the heel of the door and the abutting adjacent jamb surface whenever the door is opened.” This patent also provides for a device to cover and enclose the hinges of the door by a finger protecting safety shield.

An elongated safety hinge which is extended horizontally outward from the door jamb is the primary feature of U.S. Pat. No. 5,076,017. Further, a resilient end cap is secured to the “swing” edge of the door in order to minimize the risk of fingers being injured if caught between the door stile and the door jamb. The invention also discloses latching rods extending from the upper and lower extremities of the door.

U.S. Pat. No. 5,092,077 utilizes a variable geometry semi-rigid piece to attach to both the hinged vertical edge of the door and the door jamb. This provides finger protection in the hinged area along the length of the door.

The gap between the hinge portion of a door and the door edge is protected by an elongated finger door guard device which automatically covers the hazardous gap when the door is opened in U.S. Pat. No. 5,765,311. A similar device is used in U.S. Pat. No. 6,141,909.

U.S. Pat. No. 6,311,432 has a unique safety device designed to be fitted to the side of a door stile adjacent to the jamb, which device serves to sweep the zone between the jamb and the adjacent stile as the door is pivoted closed. The door jamb is also fitted with a pair of vertically extending shielding strips, serving to form a blocked safety area as the door swings into the closing zone.

U.S. Pat. Nos. 6,434,888, 6,832,450, and 7,047,694 all have similar elongated hinge area door guards.

### BRIEF SUMMARY OF THE INVENTION

Several unique features of this inventive concept evidence the fact that safety and ease of operation are coordinated throughout the design. The basic invention is a Door Assembly comprised of a main door, which can be of a variety of sizes and materials, a four-sided doorframe for housing the main door via a major pivotal means, a leaf door, attached to the leading edge of the main door by a minor pivotal means, and a resilient padding which fills the exposed gap along the hinged side (or trailing edge) of the main door.

An elongated rectangular portion of the leading edge of the main door is excised and the main door proximate the cutout is reinforced to support a pivoting function of the leaf door. The leaf door is a virtual miniature door designed to rotate, upon its own pivotal means, which may be an adequately tensioned spring mechanism. The pivotal axis of the leaf door is parallel to the leading edge of the main door. The leaf door normally remains flush with the main door, unless it is impeded by an object inserted at the inside front doorframe. The primary object of all the embodiments of this inventive concept is to produce a door that minimizes the danger of the fingers of a child, adult, or a small pet being (1) crushed between the leading edge of the main door and the doorframe, or (2) severely injured in the gap in the vicinity of what normally would be the hinged area, or trailing edge of a door.

Several embodiments of the Door Assembly concept feature a main door with a rounded or concave trailing edge. With such trailing edge, an axle or concentric upper and lower dowels form the major pivotal means. The present inventive concept may also utilize a length of compressible elastomeric material to fill the longitudinal gap proximate the trailing edge of the main door, where hinges would normally be located.

One aspect of the door assembly is the ability to latch the leaf door into the threshold of the doorframe as a security measure when the main door is fully closed. In a different embodiment, the main door cutout contains a lower ledge which can accommodate the latching of the leaf door, again as a security provision. When unlatched, the leaf door may rotate approximately 20 to 30 degrees by virtue of its minor pivotal means.

### BRIEF DESCRIPTION OF THE VIEWS OF THE DRAWINGS

### Index to Components of Door Assembly

1. Main Door
2. Upper Main Spindle
3. Lower Main Spindle
4. Main Spindles Rotational Axis
5. Circular Upper Housing
6. Circular Lower Housing
7. Main Door Cutout
8. Door Knob
9. Dual Action Deadbolt
10. Direction of Movement of Main Door
11. Threshold of Frame
12. Doorframe Exterior Exposure
13. Doorframe
14. Entry Side of Frame
15. Leaf Door
16. Leaf Door Upper Dowel
17. Leaf Door Lower Dowel
18. Leaf Door Pivotal Axis
19. Leaf Door Upper Circular Notch
20. Leaf Door Lower Circular Notch
21. Leaf Door Security Rod
22. Range of Movement of Leaf Door
23. Side Strike Box
24. Lower Strike Box
25. Spring Mechanism for Leaf Door
26. Vertical Deadbolt Pin
27. Horizontal Deadbolt Pin
28. Interior Surface of Main Door
29. Exterior Surface of Main Door
30. Resilient Padding
31. Trailing Edge of Main Door
32. Leading Edge of Main Door
33. Upper Reinforced Ledge
34. Lower Reinforced Ledge
35. Receptacle for Security Rod
36. Lower Strike Box
37. Retracting Spring
38. Strike Plate
39. Upper Ball Bearing Assembly
40. Lower Ball Bearing Assembly
41. Revolving Wing
42. Wing Leaf Door
43. Power-Driven Shaft
44. Upper Dowel
45. Lower Dowel
46. Upper Circular Metallic Notch
47. Lower Circular Metallic Notch
48. Spring Loading Device
49. Wing Upper Ledge
50. Wing Lower Ledge
51. Revolving Door
52. Doorframe Inner Top Surface
53. Doorframe Outer Top Surface
54. Doorframe Inner Rear Surface
55. Doorframe Outer Rear Surface
56. Doorframe Top Threshold
57. Doorframe Bottom Threshold
58. Doorframe Inner Front Surface
59. Doorframe Outer Front Surface
60. “U”-Spring Mechanism

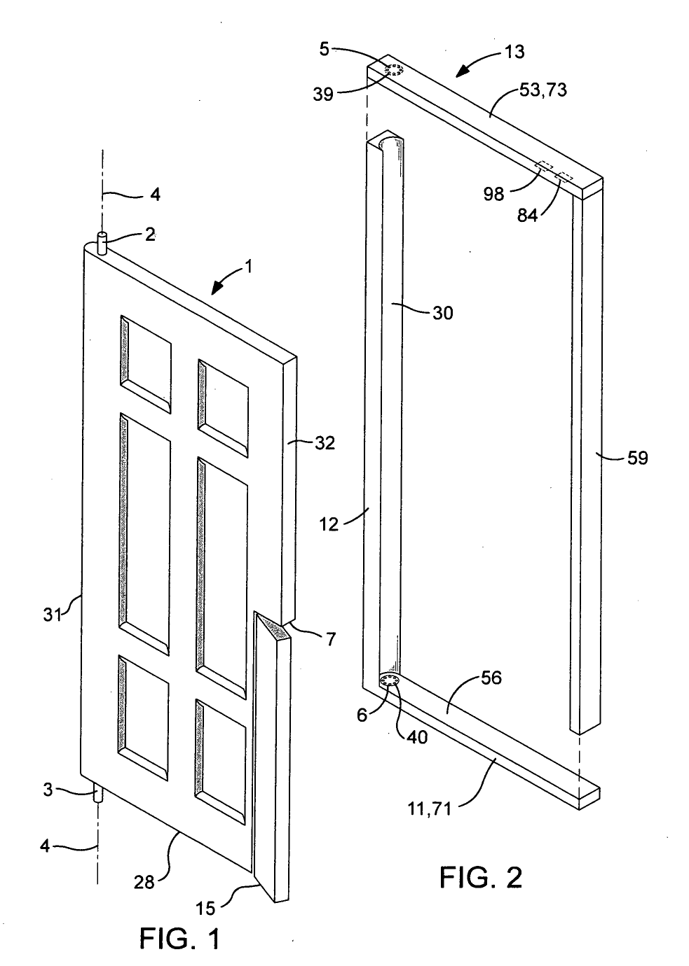

FIG. 1 presents a simplified view of the main door and a generic leaf door proximate the lower front quarter of the main door.

FIG. 2 is an exploded of the doorframe, including the locations of supporting ball bearing assemblies.

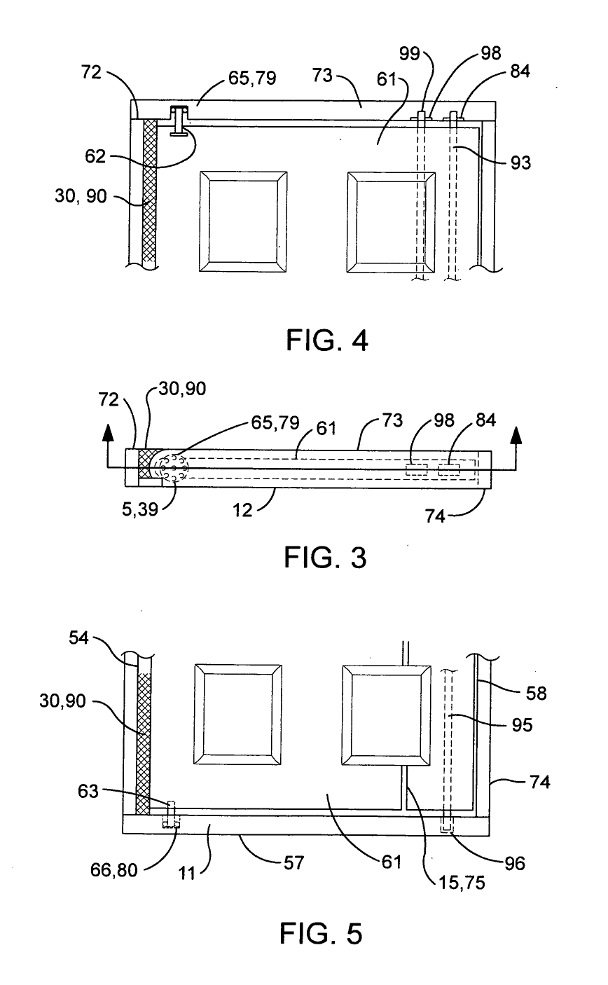

FIG. 3 is a view looking downward through the top of the doorframe and observing the enhanced main door, further depicting the upper ball bearing assembly.

FIG. 4 is a side view of a cutaway of the top portion of the Door Assembly, showing the upper ball bearing assembly, strike plate, and the upper strike box.

FIG. 5 gives a cutaway side view of the Door Assembly, showing the circular lower housing, lower ball bearing assembly, and the lower strike box.

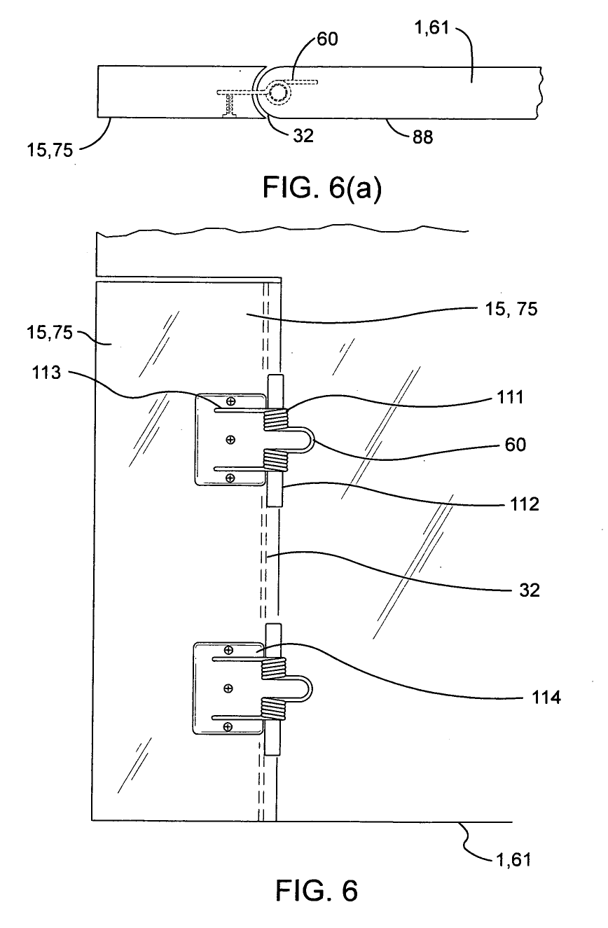

FIG. 6 presents a view of the “U” spring mechanism which may be utilized to operate the leaf door.

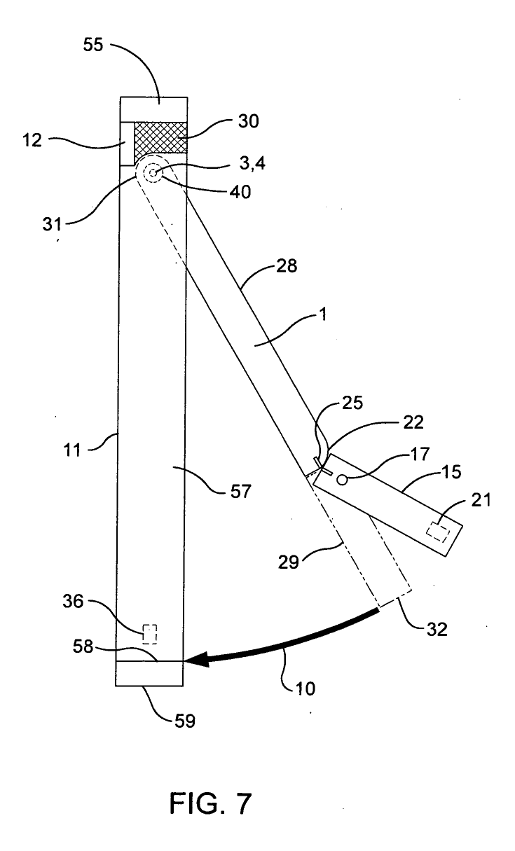

FIG. 7 is a presentation of a bottom view looking upward through the threshold and observing the main door opened while the leaf door is unlatched and ajar from its flush position with the main door.

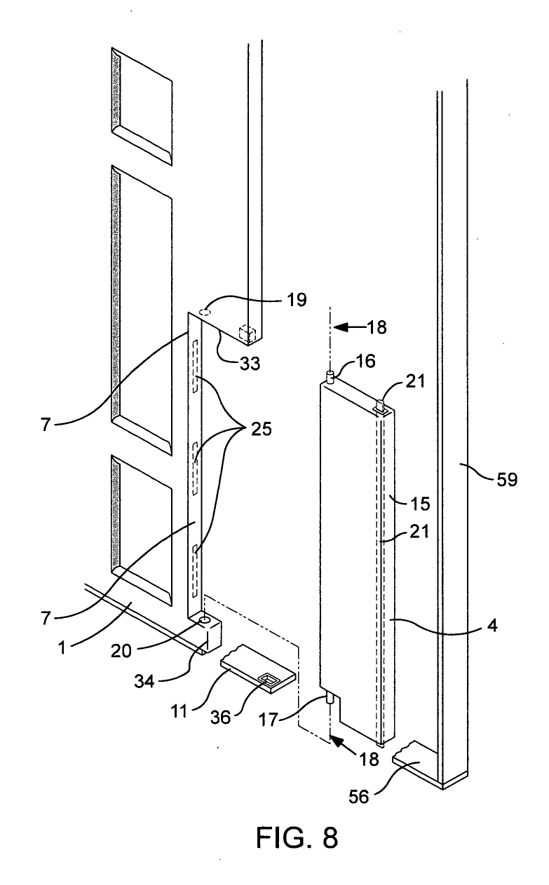

FIG. 8 is a rendering of an embodiment wherein the leaf door revolves upon a lower ledge of the main door.

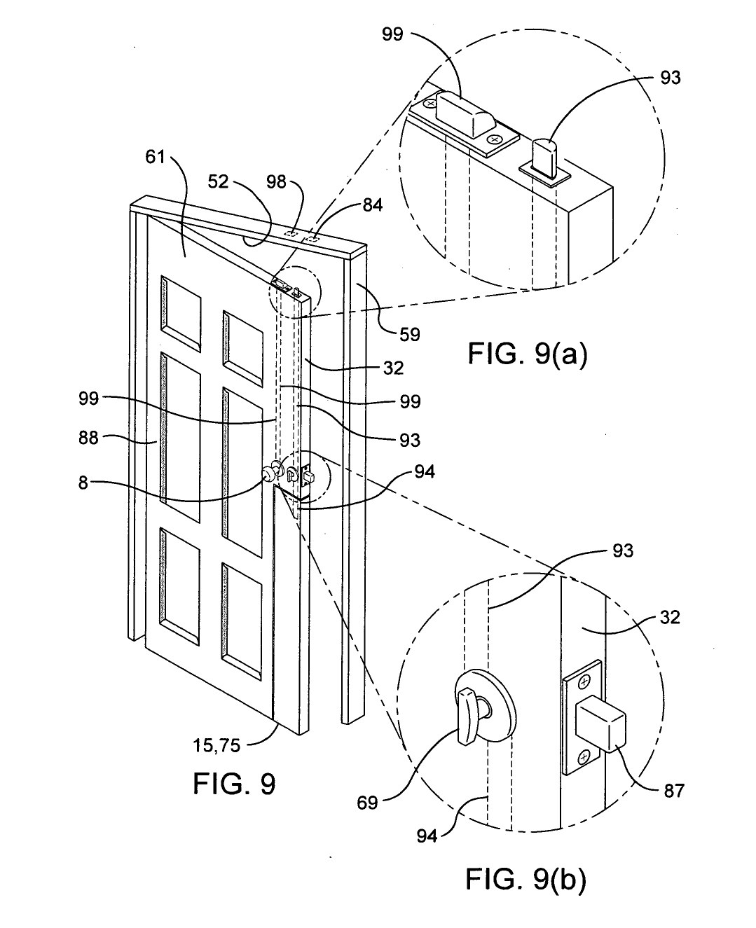

FIGS. 9, 9(a), and 9(b) show a perspective rendering of an enhanced embodiment of the invention, including two vertical security rods, a horizontal dead bolt, and the receptacles for each of these devices

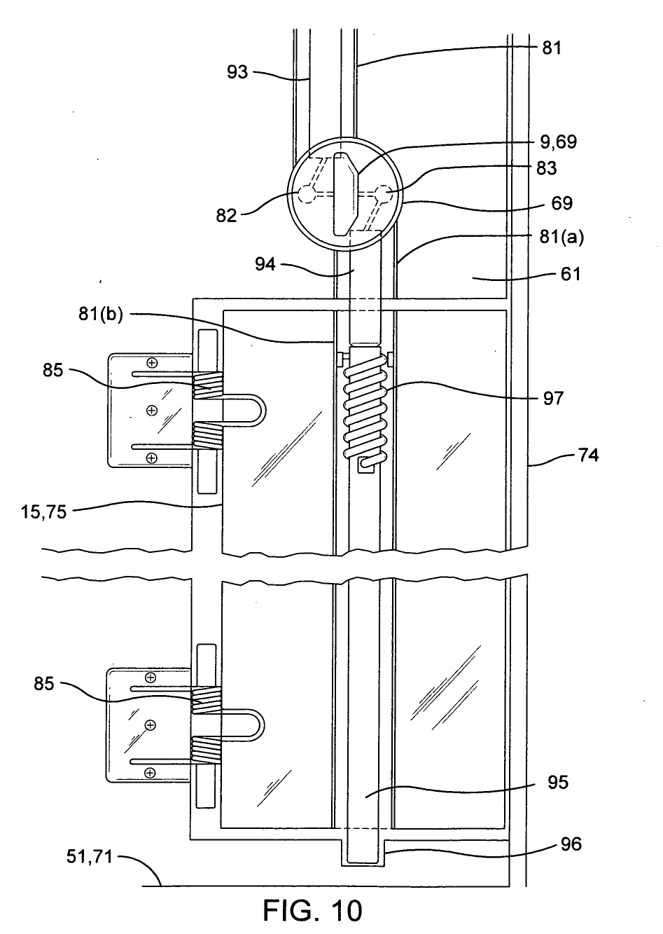

FIG. 10 is a cutaway view of the operation and interrelationship among the upper, middle, and lower security rods as they are latched and/or unlatched.

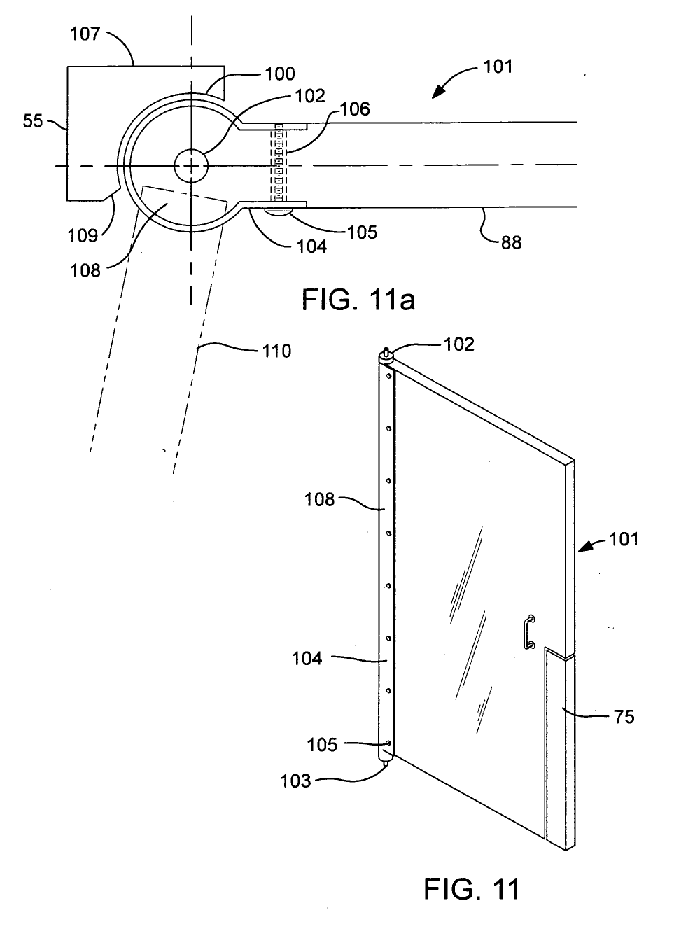

FIG. 11 presents an embodiment in which the main door contains upper and lower spindles which are embedded in, and aligned with, a rigid vertical rod, referred to as an “axle.”

FIG. 11(a) is a top view showing the main axle-door and doorframe support element.

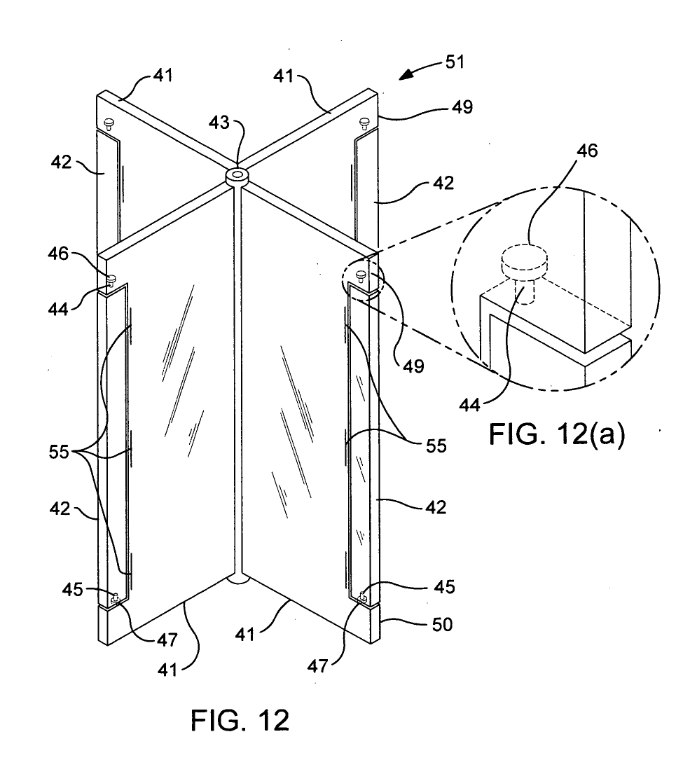

FIG. 12 illustrates an embodiment of the leaf door concept in which all four wings of a revolving door are equipped with integral spring-actuated leaf doors.

### DETAILED DESCRIPTION OF THE INVENTION

It is important to present, initially, a generalized view and summation of the operating concept of this invention. Beginning with FIG. 1, there is shown a perspective view of a generic “main door” 1, including a rectangular cutout 7, said cutout 7 precisely sized to accommodate the leaf door 15. FIG. 2 presents an exploded view of the doorframe 13. The threshold of the door frame 11, doorframe inner rear surface 54, outer top surface of door frame 53, upper strike box 83, strike plate 98, and the location of upper and lower ball bearing assemblies, 39, 40, respectively, are shown.

FIG. 1 also depicts major pivotal means comprised of an upper main spindle 2 and a lower main spindle 3, which define the rotational axis 4 about which the main door 1 revolves. The resilient padding 30 traverses the length of the doorframe inner rear surface 54, said padding covering the gap which normally exposes the hinged area of a standard door. The padding 30 is attached to the doorframe inner rear surface 54 by an adhesive or other suitable means. The padding 30 serves to prevent the insertion of fingers in the space between the main door 1 and the doorframe inner rear surface 54.

Although not shown in FIG. 1, the bottom surface of the main door 1 and the doorframe top threshold 56 may be overlaid with a layer of grooved hard rubber material. The said material may be applied to the bottom surface of the main door 1 and the doorframe top threshold 56 such that the small grooves will run lengthwise and parallel along both surfaces with the result that the grooves are relatively interlocking with each other when the main door 1 is closed. This feature will further serve as a weather-tight barrier against the elements.

The top of the frame 53 features a built-in circular upper housing 5. This housing contains a ball bearing assembly designed to accept the upper main spindle 2. An appropriate assembly may be comprised of spindle bearings or any other type of bearings particularly suitable for both rotational guidance of a shaft, and a moderate capacity for radial load bearing. The top frame member 53 is explained with more detail in FIG. 7, below.

FIG. 3 illustrates a view of the Door Assembly looking downward through the top of the frame 73. The main door 1, or enhanced main door 61, is shown closed and the leaf door security rod 21 has been unlatched, allowing the leaf door 15 to pivot slightly ajar. Should an object, such as a finger, become lodged between the leaf door 15 and the doorframe inner front surface 58, the leaf door 15 is prevented from closing with its full weight and rigidity as it approaches doorframe inner front surface 58, and thus severe injury is be avoided. Observing the leftmost portion of FIG. 3, the padding 30, 90 adhering to the doorframe inner rear surface 54 is depicted. The circular upper housing 5, 65, which will contain the upper ball bearing assembly 39, is also shown.

FIG. 4 depicts a cutaway rendering of a side view of the top of the frame 73. The enhanced main door 61 is presented in the closed position. Both the main latching rod 99 and the upper security rod 93 are latched into the strike plate 98 and the upper strike box 84, respectively. The bottom end of the upper main spindle 62 is shown as anchored into the enhanced main door 61. The main door's upper circular housing 65 is shown as it fits into the upper frame 73. The said housing also contains the upper ball bearing assembly 79 which supports and guides the radial motion of the upper main spindle 62.

As we examine FIG. 5, a cutaway of the side view of the frame threshold 11 is shown, as well as contiguous portions of the concave mounting side of the frame 72 and the entry side of the frame 74. The circular lower housing 66 is shown as it is embedded in the threshold 71. This housing contains the lower ball bearing assembly 80, which in turn provides load support for the enhanced main door 61, radial stability for the lower main spindle 63, and a relatively friction-free rotational platform for the lower main spindle 63. The lower security rod 95 is depicted as being inserted into the lower strike box 96, thus providing a secure latching condition for the door assembly.

Continuing to examine FIG. 5, it is seen that the leftmost portion of the threshold 11 is constructed with a built-in circular lower housing 66. This housing contains a customized ball bearing assembly 80 designed to accept the lower main spindle 63 and also support the weight and rotation of the enhanced main door 61. An appropriate ball bearing assembly 80 may be comprised of any of a selection of axial spherical roller bearings, axial cylindrical roller bearings, or axial deep groove ball bearings. Each of these species of ball bearing assemblies has high load carrying capacity, excellent durability, and is suitable for guiding the lower main spindle 63.

FIG. 6 presents a pair of “U” springs 60 that are of practical consideration for use in the operation of the leaf door 15, 75. The coil 111 of each of the U-springs 60 is partially welded to a vertical spring rod 112 which is affixed to a recess within the rounded leading edge 32 of the main door 1, 61. The extended prongs 113 of each U-spring 60 are in turn welded to a mounting plate 114 which is attached by appropriate means to the leaf door 15, 75.

FIG. 7 illustrates the coordinated operation of the trailing edge of the door 32, the main door 1, and the leaf door 15, as seen looking from the floor, upwards through the threshold of the frame 11. The main door 1 is shown open and the leaf door 15 is depicted unlatched and lagging slightly behind the position of flush alignment with the main door 1. The resilient padding 30 is shown compressed toward the interior surface 28 of the door. The main door 1 has been opened by pushing it about its rotational axis 4, the lower line of said axis extending coaxially through the lower main spindle 3 and the circular lower housing 6.

When the main door 1 is pushed closed, in the direction of its arc of movement 10 shown, the leaf door 15 in turn may be pushed fully closed and flush with the main door 1. The leaf door 15 may then be latched by a turn of the dual action deadbolt 9 pushing the leaf door security rod 21 downward into its fitted receptacle 36, which is located in the threshold 11.

FIG. 7 demonstrates that, in the unlatched position, the leaf door 15 provides protection against accidental crushing of a finger which may be accidentally caught between the leading edge of the main door 32 and the inner front surface 58 of the doorframe. As the main door 1 closes, the leaf door 15, being unlatched, lags slightly behind the surface of the main door 1, and may make blunted contact with the finger. As the contact takes place, it will be with substantially reduced force since the spring mechanism 25 does not permit the leaf door 15 to contact the inner front surface 58 of the doorframe with the same rigidity as the main door 1. Thus, serious injury is avoided. Once the main door 1 is safely closed, the leaf door 15 may then be secured by operation of the dual action dead bolt lock 9 as it activates the leaf door security rod 21.

FIG. 8 depicts an alternative embodiment of the leaf door 15 and a different method of attachment to the main door 1. The embodiment in FIG. 8 depicts an alternative arrangement whereby the leaf door 15 is mounted between an upper reinforced ledge 33 and a lower reinforced ledge 34 within the main door cutout 7. For clarity, the leaf door 15 is shown separated from its junction with the main door 1. As a means of security, a leaf door latch (not shown) may be used to operate, in a vertical orientation, an internal leaf door security rod 21 which snugly fits into a lower strike box 36 within the threshold 11 when the leaf door 15 is closed flush with the main door.

Also pictured in FIG. 8 is the leaf door upper circular notch 19, which is built into the upper portion of the main door cutout 7 so as to provide both a form-fitted recess and rotational stability for the leaf door upper dowel 16. The leaf door lower circular notch 20 is cut into the main door lower reinforced ledge 34 and serves to accommodate and provide rotational stability for the leaf door lower dowel 17. As the leaf door 15 is operated to and from the latched and/or unlatched positions, it pivots about its pivotal axis 18, which axis is defined by the co-located centerlines of the upper and lower circular notches 19, 20.

FIG. 8 shows an effective location of one or more spring mechanisms 25 for the leaf door 15, which is a position firmly affixed to mid-length of the main door cutout 7. It is anticipated that a number of variations of spring means will prove to be effective as the inventive concept is modified. Another possible spring mechanism 25 includes the use of matching upper and lower helical torsion springs. One end of the upper helical torsion spring affixed to the upper circular notch 19 and one end of the lower helical torsion spring affixed to the lower circular notch 20 of the leaf door 15. The remaining end of each respective helical torsion spring will be attached at a point on the leaf door 15 so as make the axis of each helical torsion spring co-located with the pivotal axis 18 of the leaf door 15.

Door Assembly with Enhanced Security Features

In referring to several of the figures, enhancements of the basic embodiment of the Door Assembly are shown. A supplemental Index to Components follows:
61. Enhanced Main Door
62. Upper Main Spindle
63. Lower Main Spindle
64. Main Spindles Rotational Axis
65. Circular Upper Housing
66. Circular Lower Housing
67. Main Door Cutout
68. Door Knob
69. Latching Deadbolt
70. Direction of Movement of Main Door
71. Frame Threshold
72. Concave Mounting Side of Frame
73. Top of Frame
74. Entry Side of Frame
75. Leaf Door
76. Leaf Door Upper Dowel
77. Leaf Door Lower Dowel
78. Leaf Door Pivotal Axis
79. Upper Ball Bearing Assembly
80. Lower Ball Bearing Assembly
81. Tubular Housing
89. Exterior Surface of Main Door
90. Resilient Curtain/Padding
91. Convex Trailing Edge of Door
92. Leading Edge, Main Door
93. Upper Security Rod
94. Middle Security Rod
95. Lower Security Rod
96. Lower Strike Box
97. Retraction Spring
98. Strike Plate
99. Main Latching Rod
100. Doorframe Inner Curvature
101. Main Axle-Door
102. Upper Spindle
103. Lower Spindle
104. Casing
105. Bolt
106. Threaded Shaft
107. Doorframe Support Element
108. Axle
109. Inner Angle 82. Left Mechanical Linkage 110. Open Position 83. Right Mechanical Linkage 111. Coil 84. Upper Strike Box 112. Spring Rod 85. Spring Mechanism for Leaf Door 1113. Prong 86. Vertical Deadbolt Pin 114. Mounting Plate 87. Horizontal Deadbolt Pin 88. Interior Surface of Main Door

As we view FIGS. 9, 9(a), and 9(b), security latching mechanisms of an embodiment of the door assembly are presented. The leaf door 15, 75 may, during normal use, be latched to the main door 1, 61, by means of the dual action deadbolt 69. The dual action deadbolt 69 is connected to an upper security rod 93 and a horizontal deadbolt pin 87. FIG. 10 also presents close-up view of the functioning of the various mechanisms. When the dual action deadbolt 69 is turned to the latched position, it will simultaneously force the middle security rod 94 downward, forcing the lower security rod 95 (also referred to as the leaf door security rod 21 in the basic embodiment) into the lower strike box 96 and simultaneously pushing the horizontal deadbolt pin 87 into the side strike box 23 (not shown). The leaf door security rod receptacle 96 is cut into the threshold 71 and thus provides an extra measure of security and leaf door stability.

The embodiment shown in FIGS. 9, 9(a), and 9(b) operates in much the same manner as the basic embodiment. The most noticeable modification in the enhanced embodiment as shown is the inclusion of an upper security rod 93, middle security rod 94, and lower security rod 95. With the enhanced main door 61 shown partially open, the upper 93, middle 94, and lower security rod 95 are all indicated by dashed lines. In the operating embodiment of this invention, metal tubes, slightly larger in diameter than the aforementioned security rods will envelope the entire length of each of the said rods. The tip of the main latching rod 99 is shown extending above the top edge of the door. This is the normal functional position of the main latching rod 99 whether the enhanced main door 61 is open or closed. The door knob 8, 68 controls the operation of the main latching rod 99 in a manner comparable to the spindle of a conventional doorknob controlling the sidewise-oriented deadbolt in a doorknob and strike plate combination.

For illustrative purposes only, the upper security rod 93 and the lower security rod 95 are both shown extended into their “latched” position. However, the enhanced main door 61 may only be latched for security purposes when the door is fully closed. After closing the enhanced main door 61, the latching deadbolt 69 is rotated clockwise, causing mechanical linkages connected to both the upper security rod 93 and the lower security rod 95 to be displaced. Movement of the linkages forces the upper security rod 93 upward into the upper strike box 84, and the lower security rod 95 into its lower strike box 96.

FIG. 10 presents a closer view of the operation of the upper and lower security rods 93, 95. Shown is a cutaway view of the relevant portions of the enhanced main door 61 and the leaf door 75 with both the upper and lower security rods 93, 95 in the latched position. The upper security rod 93 and the lower security rod 95 are each enclosed in similar tubular housings 81, 81(a), 81(b) to guide their vertical movement within the enhanced main door 61. The latching deadbolt 69 is pictured as having been turned clockwise to its vertical position. This action has caused the left mechanical linkage 82 to move the upper security rod 93 into the upper strike box 84 (not shown). This position of the latching deadbolt 69 has also caused the right mechanical linkage 83 to move a middle security rod 94 downward against the lower security rod 95, thereby forcing the lower security rod 95 into the lower strike box 96. Further, the latching position of the latching deadbolt 69 has also placed the retraction spring 97 into tension.

Upon turning the latching deadbolt 69 counter-clockwise to its horizontal unlatched position, the left mechanical linkage 82 retracts the upper security rod 93 from the upper strike box 84 and causes the rod 93 to be stowed within the enhanced main door 61. Simultaneously, the right mechanical linkage 83 retracts the middle security bolt 94 upward, which relieves the downward pressure on the lower security rod 95. Thereupon, the retraction spring 97 compresses and pulls the lower security rod 95 out of the lower strike box 96. The leaf door 15, 75 is then free to pivot in its injury-preventing mode.

### Other Embodiments and Applications of the Door Assembly

Again referring to FIG. 1, a number of modifications and additions to the basic door assembly can be projected. For instance, a different embodiment of this invention would entail increasing the relative size of the leaf door 15 by extending its length vertically so as to encompass all, or a portion of, the leading edge of the main door 1 above the door knob or handle. The increased size of the leaf door 15 may require a series of spring mechanisms 25 in order to provide sufficient tension, symmetry, and balance to properly position the leaf door 15 throughout the operating range of the enhanced main door 1.

In reviewing FIG. 8., it must be noted that, although not shown in the present embodiments, design features may be incorporated whereby both the upper circular housing 65 and the lower circular housing 66 are constructed with a “quick release” feature built into the frame which feature will allow an effective means of removal of either housing for lubrication of the components or replacement of the ball bearing assemblies 79, 80.

A variety of spring means 25 (FIG. 2.) may be incorporated into the different embodiments of this inventive concept. One type of spring mechanism consists of a continuous spring-loaded hinge, similar to a piano hinge. This hinge runs the entire length of the pivoting edge of the leaf door 15 and thus serves to define the leaf door pivotal axis 18. A second possible type of spring is the commonly used auto-locking bifold spring which also can operate effectively in this invention when it is appropriately attached to both the enhanced main door 61 and the leaf door 15.

As another consideration for effective functioning of the invention, manufacture of the door assembly may be enhanced by incorporating miniature spring-loaded cabinet hinges or Euro-hinges as the spring mechanism 25 in the design of the leaf door 15. As further consideration, FIG. 6 presents a combination of two “U”-springs connecting the leaf door 15 and the enhanced main door 61

A further improvement to this inventive concept comprises the application of an optimum thickness of rubberized or plastic-type material along the entire leading edge 32 of the main door and also application of the same material along the entry side of the doorframe 14. Such material further serves the primary object of the invention, which is to minimize the possibility of serious injury in the event a finger is caught between the leaf door 15 and the entry side of the doorframe 14.

### Embodiment

### Door Assembly With Integral Axle

In referring to FIG. 11, an embodiment of this inventive concept is shown with a main axle-door 101 constructed with an integral door axle 108 and the previously disclosed leaf door 75. The door axle 108 is of a diameter slightly larger than the main axle-door 101 thickness and additionally has embedded in it, at opposite ends, the spindle 102 and lower spindle 103 of the main axle-door 101. The door axle 108 is of sufficient strength and rigidity as to provide a durable and steady axis for opening and closing of the main axle-door 101. Owing to the increased diameter of the door axle 108 relative to the thickness of the main axle-door 101, a variable-shaped doorframe 107 is required to support the pivotal functioning of the main axle-door 101, in which the inner back surface of the previously disclosed doorframe is modified. A top view of the cross-section of such modified inner back surface is shown in FIG. 11. The door axle 108 may further be tightly enclosed in a casing 104, composed of metal or other suitable material. The casing 104 may be press-fitted against the door axle 108 or secured with bolts 105 along the length of the main axle-door 101. The casing enhances endurance, security, and all-weather protection.

In viewing FIG. 11(a), a top view of the main axle-door 101 and variable-shaped doorframe 107 is presented. The upper spindle 102 and a portion of the main axle-door 101 are shown in the door closed position. The dashed lines indicate the position of the main axle-door 101 were it fully opened 110. In the fully open position 110 sufficient clearance from the doorframe support element 107 is provided by a beveled angle 109, which allows sufficient room for pivoting of the main axle-door 101.

It can be seen that, as the main axle-door 101 revolves open or closed, the door axle 108 rotates in close proximity to the inner curvature 100 of the doorframe support element 107. This close spacing between the main door axle 108 and the inner curvature 100 of the doorframe support element 107 serves a critical safety function in that the close tolerance prevents the insertion of a finger into what would normally have been the gapped hinged area of a conventional door.

### Office and/or Commercial Embodiment

In FIG. 12, a commercial application of this invention is shown wherein each of the four wings 41, of a revolving door 51 is designed to function utilizing the leaf door concept. This embodiment of the safety door design is particularly applicable to public or commercial buildings equipped with revolving doors. As shown in FIG. 12, each of the wings 41 is attached to a common door shaft 43. The door shaft 43 may be electrically or mechanically powered to simultaneously rotate the wings, normally counter-clockwise, in response to pedestrian traffic moving through the door. Each wing 41 contains a leaf door 42, which may pivot, by means of an upper dowel 44 and a lower dowel 45 embedded in the respective leaf door 42, about an axis running concentrically through each paired upper and lower dowel 44, 45. Each upper dowel 44 is contained in an upper circular metallic notch 46 and each lower dowel 45 rests in a lower circular metallic notch 47. The circular notches are built into the respective upper ledge 49 and lower ledge 50, with each ledge being an integral part of the structure of each wing 41.

A plurality of spring-loading devices 48 are regularly spaced along the junction of each leaf door 42, and its respective wing 41. The spring-loading devices 48 assist in moderating the closing force of their respective leaf doors 42 in the event an obstruction is encountered during closing of the revolving door 51. Each leaf door 42 is generally 75% to 90% of the height of its respective wing 41.

Having described the basic and the enhanced embodiments of this Safety Door Assembly, it is believed that other modifications, improvements, and changes will be suggested to those skilled in the art in view of the teachings set forth herein. It is therefore to be understood that all such variations, improvements, and changes are encompassed within the scope of the present invention.

What is claimed is:

1. A door assembly apparatus comprising:
a main door;
a doorframe comprising a hollow rectangular cuboid of four paired surfaces, specifically, inner and outer top surfaces, inner and outer rear surfaces, inner and outer threshold surfaces, and inner and outer front surfaces, and further, of interior dimensions sufficient to accommodate said main door;
a major pivotal means;
a leaf door;
a minor pivotal means; and
a spring mechanism;
wherein said main door is attached to said doorframe by said major pivotal means, said leaf door is affixed, by said minor pivotal means, within a rectangular cutout excised from a portion of the leading edge of said main door, and further, said leaf door is held in a flush orientation with said main door by virtue of said spring mechanism.

2. A door apparatus as in claim 1, wherein (a) said main door is constructed with a lengthwise convex trailing edge and (b) said doorframe exhibits an elastomeric material affixed along the length of the inner rear surface of said doorframe.

3. A door apparatus as in claim 1, wherein
a) said major pivotal means comprises i) an upper rod inserted vertically downward into the top of said main door proximate and parallel to the trailing edge of said main door; and ii) a lower rod inserted upward into the bottom of said main door proximate and parallel to the trailing edge of said main door, said upper rod and lower rod being co-axial; and
b) said doorframe further comprises i) an upper bearing assembly for reception of said upper rod, said upper bearing assembly integral to the inner top surface of said doorframe proximate the junction of the inner top surface and the inner back surface of said doorframe, and ii) a lower bearing assembly for reception of said lower rod, said lower bearing assembly being integral to said inner threshold surface, proximate the junction of the inner threshold surface and the inner back surface of said doorframe.

4. A door apparatus as in claim 1, wherein
a) said major pivotal means comprises a continuous axle, having an upper end and a lower end, said axle embedded in the trailing edge of said main door, with the upper end of said axle extending slightly above the top of said main door proximate, and parallel to, the trailing edge of said main door; and the lower end of said axle protruding slightly below the bottom of said main door proximate, and parallel to, the trailing edge of said main door; and
b) said doorframe comprises i) an upper bearing assembly for reception of the upper end of said axle, said upper bearing assembly integral to the inner top surface of said doorframe proximate the junction of the inner top surface and the inner back surface of said doorframe, and ii) a lower bearing assembly for reception of the lower end of said axle, said lower bearing assembly being integral to said inner threshold surface, proximate the junction of the inner threshold surface and the inner back surface of said doorframe.

5. A door apparatus as in claim 1, wherein
said minor pivotal means comprises at least one spring mechanism affixed between the pivoting edge of said leaf door and the cutout of said main door, said spring mechanism selected from the group consisting of a u-spring, a plate spring, a coil spring, and a helical torsion spring.

6. A door apparatus as in claim 1, wherein
said major pivotal means comprises a plurality of hinges, said hinges attaching the trailing edge of said main door to the inner back surface of said doorframe.

7. A door apparatus as in claim 1, wherein
said minor pivotal means is selected from a group consisting of upper and lower coaxial dowels, upper and lower coaxial pins, and an axle extending at least the length of the trailing edge of said main door.

8. A door apparatus as in claim 1, wherein
said rectangular cutout comprises an upper ledge and a lower ledge, and further, said minor pivotal means comprises, i) an upper dowel affixed to the top of the pivoting edge of said leaf door, ii) a lower dowel affixed to the bottom of the pivoting edge of said leaf door, the said upper and lower dowels being co-axial, and iii) at least one spring mechanism connecting the pivoting edge of said leaf door to said cutout.

9. A door assembly apparatus comprising:
a main door,
a doorframe comprising a hollow rectangular cuboid of four paired surfaces, specifically, inner and outer top surfaces, inner and outer rear surfaces, inner and outer threshold surfaces, and inner and outer front surfaces;
a major pivotal means,
a leaf door,
a minor pivotal means, and
a spring mechanism,
a major latching mechanism and
a minor latching mechanism, wherein
a) said main door comprises, as a major pivotal means, an integral axle, having an upper end and a lower end, said axle attached to and parallel to the trailing edge of said main door, said main door further having a rectangular cutout excised from, and parallel to, the leading edge of said main door;
b) said doorframe comprises a hollow rectangular cuboid of four paired surfaces, specifically, inner and outer top surfaces, inner and outer rear surfaces, inner and outer threshold surfaces, and inner and outer front surfaces;
c) said doorframe further comprises i) an upper bearing assembly for reception of the upper end of said axle, said upper bearing assembly integral to the inner top surface of said doorframe proximate the junction of the inner top surface and the inner back surface of said doorframe, and ii) a lower bearing assembly for reception of the lower end of said axle, said lower bearing assembly being integral to said inner threshold surface, proximate the junction of the inner threshold surface and the inner back surface of said doorframe;
d) said leaf door comprises dimensions commensurate with a flush fit within the indentation in said main door, and further having a minor pivotal means, said minor pivotal means connecting said leaf door to the cutout in said main door;
e) said main door, when rotated about the rotational axis of said major pivotal means and closed within said doorframe, may be attached to at least one inner surface of said doorframe by said major latching mechanism; and
f) said leaf door, when rotated about the vertical axis of said minor pivotal means to a position flush with said main door, may be fixed to said threshold of said main door by said minor latching mechanism.

10. A door apparatus as in claim 9, wherein
a) said major pivotal means comprises an upper dowel and a lower dowel, both coaxial, with said co-axis extending proximate, and parallel to, the trailing edge of said main door; and b) said doorframe comprises an upper bearing assembly and a lower bearing assembly capable of receiving said upper dowel and said lower dowel, respectively.

11. A door apparatus as in claim 9, wherein
said minor pivotal means comprises at least one spring mechanism affixed between the pivoting edge of said leaf door and the vertical segment of said indentation in said main door, said spring mechanism selected from the group consisting of a u-spring, a plate spring, and a helical torsion spring.

12. A door apparatus as in claim 9, wherein
said minor pivotal means comprises, i) an upper dowel affixed to the top of the pivoting edge of said leaf door, ii) a lower dowel affixed to the bottom of the pivoting edge of said leaf door, the said upper and lower dowels being co-axial, and iii) at least one spring mechanism connecting the pivoting edge of said leaf door to the indentation in said main door.

13. A method for improving safety with respect to the potential for severe finger injuries in the area of the immediate vicinity of a residential or commercial doorway, said doorway fitted with a conventionally operating door, the improvement being the installation of a door assembly comprising
a main door having a convex-shaped trailing edge and having a rectangular cutout proximate the leading edge of said main door;
a doorframe having a rectangular shape with four inner surfaces and dimensions suitable to accommodate said main door, and further, having an elastomeric material affixed to the inner rear surface;
a major pivotal means for said main door;
a leaf door of dimensions suitable for fit within said cutout;
a minor pivotal means for operation of said leaf door;
a spring mechanism of adequate tension to align said leaf door flush with said main door and having compression relief suitable to retract said leaf door;
a major latching mechanism; and
a minor latching mechanism.
